(19) United States
(12) Patent Application Publication
(10) Pub. No.: US 2009/0316063 A1
(43) Pub. Date: Dec. 24, 2009

(54) LIQUID CRYSTAL DISPLAY DEVICE

(75) Inventor: Saburo WATANABE, Ichinomiya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/487,858

(22) Filed: Jun. 19, 2009

(30) Foreign Application Priority Data
Jun. 20, 2008 (JP) 2008-162181

(51) Int. Cl. G02F 1/1333

(52) U.S. Cl. 349/58

(57) ABSTRACT

A liquid crystal display device includes a liquid crystal display panel and a backlight irradiating the liquid crystal display panel with light. The backlight has a plurality of light emitting elements, a circuit board on which the light emitting elements are mounted, a light guide plate irradiating the liquid crystal display panel with the light emitted from the light emitting elements, a resin mold housing the light guide plate, and a metal case housing the resin mold. The resin mold has a plurality of protruding portions on a bottom surface facing the metal case. The metal case has a plurality of opening portions on a bottom surface facing the resin mold. The protruding portions of the resin mold and the opening portions of the metal case are fitted together.

### CROSS-REFERENCE TO RELATED APPLICATION

The present application claims priority from Japanese application JP 2008-162181 filed on Jun. 20, 2008, the content of which is hereby incorporated by reference into this application.

### BACKGROUND OF THE INVENTION

1. Field of the Invention

The present invention relates to a liquid crystal display device and particularly to a technology effectively applied to a liquid crystal display device having a light guide plate type backlight which uses light emitting diodes (LEDs) as light sources.

2. Background Art

Heretofore, liquid crystal display devices have been used for, for example, a display part of a portable electronic device because it is thin, light in weight, and consumes less power.

However, since the liquid crystal display device is not self-luminous, it requires a lighting means for clearly displaying a video or image. For the lighting means of the liquid crystal display device, a planar lighting device generally referred to as a backlight is used. Many heretofore known backlights have used cold cathode fluorescent tubes as light emitting elements (also referred to as light sources). In recent years, a backlight using light emitting diodes (LEDs) as light emitting elements has increased. The backlight using light emitting diodes has been particularly employed in a liquid crystal display device used for a display part of a portable electronic device in many cases.

The backlight of the liquid crystal display device used for a display part of a portable electronic device is mainly referred to as of a light guide plate type (also referred to as of an edge light type). In the light guide plate type, a light guide plate is arranged at a position facing a display region of a liquid crystal display panel. Light emitting elements are arranged at a position facing a side surface of the light guide plate.

In the backlight using light emitting diodes, the light emitting diodes and the light guide plate are housed in and fixed to a box-shaped metal case, for example. In such a backlight, the light emitting diodes are attached to the metal case to thereby effectively dissipate the heat generated by the light emitting diodes via the metal case, for example. Such a configuration is described in, for example, JP-A-2003-281924. However, JP-A-2003-281924 does not describe a problem that the positional relationship between the light emitting diodes and the light guide plate varies.

Further, in the backlight using light emitting diodes, a thermal conductive sheet is packed in the vicinity of the light emitting diodes to effectively dissipate the heat generated by the light emitting diodes via the metal case in some cases, for example. Such a configuration is described in, for example, JP-A-2006-235399. However, JP-A-2006-235399 does not describe a problem that the positional relationship between the light emitting diodes and the light guide plate varies.

### SUMMARY OF THE INVENTION

In the liquid crystal display device having the backlight using light emitting diodes, when the number of light emitting diodes to be used is increased for higher luminance, the operation temperature of the light emitting diodes increases, resulting in a problem that the light emitting efficiency of the light emitting diodes is reduced. Therefore, the heretofore known backlight using light emitting diodes employs a configuration which can effectively dissipate the heat generated by the light emitting diodes.

In order to realize a backlight capable of more effectively dissipating heat, for example, a configuration in which light emitting diodes are brought into contact with a heat dissipating member is conceivable. However, such a configuration causes another problem that the heat dissipating member restricts the positioning of the light emitting diodes. Therefore, problems relating to the reliability of the backlight arise in that, for example, the positional relationship between the light emitting diodes and the light guide plate varies for each liquid crystal display device, and that luminance fluctuates each device.

An object of the invention is to provide a technology capable of effectively dissipating heat of light emitting elements and making alignment between light emitting diodes and a light guide plate easy in a liquid crystal display device having a light guide plate type backlight.

The foregoing and other objects of the invention and the novel features thereof will be apparent from the description in the specification and the accompanying drawings.

Typical outlines of the invention disclosed herein will be briefly described below.

A liquid crystal display device includes a liquid crystal display panel and a backlight irradiating the liquid crystal display panel with light. The backlight has a plurality of light emitting elements, a circuit board on which the light emitting elements are mounted, a light guide plate irradiating the liquid crystal display panel with the light emitted from the light emitting elements, a resin mold housing the light guide plate, and a metal case housing the resin mold. The resin mold has a plurality of protruding portions on a bottom surface facing the metal case. The metal case has a plurality of opening portions on a bottom surface facing the resin mold. The protruding portions of the resin mold and the opening portions of the metal case are fitted together.

Light emitting diodes are used for the light emitting elements.

The plurality of light emitting elements are mounted on the single circuit board.

The plurality of light emitting elements each have a light exit surface facing one side surface of the light guide plate.

The plurality of light emitting elements are linearly arranged along one side surface of the light guide plate.

The resin mold has recessed portions on a back surface of a bottom surface having the protruding portions at positions where the protruding portions are disposed, and has a thickness at the protruding portion substantially equal to that of a portion where the protruding portion is nod disposed.

The protruding portions of the resin mold each have first side surfaces extending in a first direction and second side surfaces extending in a second direction. A gap between the opening portion and the protruding portion is smaller at the second side surface than at the first side surface.

The light guide plate has recessed fixing portions respectively disposed on two side surfaces facing each other. The resin mold has projecting portions each projected to a fixing portion side at positions facing the fixing portions of the light guide plate. The projecting portions of the resin mold and the fixing portions of the light guide plate are fitted together.

The resin mold has a hollow portion in the projecting portion which fits to the fixing portion of the light guide plate.

A cushion material is interposed between the light guide plate and the resin mold.

According to the invention, in a liquid crystal display device having a light guide plate type backlight which uses light emitting diodes, the heat of the light emitting diodes can be effectively dissipated. Further, according to the invention, the alignment between the light emitting diodes and a light guide plate is easy, and the positional relationship can be stabilized. Accordingly, the liquid crystal display device of the invention can improve the reliability of a backlight.

### BRIEF DESCRIPTION OF THE DRAWINGS

FIG. 1 is a schematic view showing an example of a schematic configuration of a liquid crystal display device of an embodiment according to the invention;

FIG. 2A is a schematic plan view of a light emitting element in the liquid crystal display device of the embodiment as viewed from a light exit surface;

FIG. 2B is a schematic view showing an example of a cross sectional configuration of the light emitting element as viewed upwardly from line A-A′ in FIG. 2A;

FIG. 3A is a schematic plan view showing an example of a schematic configuration of a region and its vicinity where one light emitting diode is to be mounted in a printed wiring board;

FIG. 3B is a schematic cross sectional view showing an example of a cross sectional configuration taken along line B-B′ when a light emitting diode is mounted on the region shown in FIG. 3A;

FIG. 4A is a schematic plan view showing an example of a schematic configuration of a printed wiring board as viewed from the light exit surface of light emitting diodes;

FIG. 4B is a schematic side view showing an example a schematic configuration of the printed wiring board in FIG. 4A as viewed from the lower side surface;

FIG. 4C is a schematic perspective view showing an example of a schematic configuration of the printed wiring board in FIG. 4A as viewed obliquely from the lower right side;

FIG. 5 is a schematic exploded perspective view showing an example of a schematic configuration of a backlight in the liquid crystal display device of the embodiment;

FIG. 6A is a schematic plan view showing an example of a schematic configuration of a portion where one protruding portion of a resin mold and an opening portion of a housing case are fitted together;

FIG. 6B is a schematic plan view showing an example of a schematic configuration of a portion where another protruding portion of the resin mold and another opening portion of the housing case are fitted together;

FIG. 6C is a schematic cross sectional view showing an example of a state where the protruding portion of the resin mold and the opening portion of the housing case are fitted together as viewed downwardly from line C-C′ in FIG. 6A;

FIG. 7A is a schematic exploded perspective view showing an example of a schematic configuration of the backlight of a first application example;

FIG. 7B is a schematic exploded perspective view showing the relationship between the protruding portions of a resin mold and the opening portions of a housing case in the backlight of the first application example;

FIG. 7C is a schematic cross sectional view showing an example of a schematic configuration in the vicinity of a light emitting diode in the backlight of the first application example;

FIG. 7D is a schematic plan view showing an example of a fixing method of a light guide plate in the backlight of the first application example;

FIG. 7E is a schematic plan view showing an example of a fixing method of optical sheets in the backlight of the first application example;

FIG. 8A is a schematic exploded perspective view showing an example of a schematic configuration of the backlight of a second application example;

FIG. 8B is a schematic exploded perspective view showing the relationship among a light guide plate, a resin mold, and a housing case in the backlight of the second application example; and

FIG. 9 is a schematic view showing a third application example of the backlight of the embodiment.

### DETAIL DESCRIPTION OF THE EMBODIMENTS

Hereinafter, the invention will be described in detail together with an embodiment with reference to the drawings. Throughout the drawings for explaining the embodiment, elements having the same function are denoted by the same reference numerals, and the repetitive description thereof is omitted.

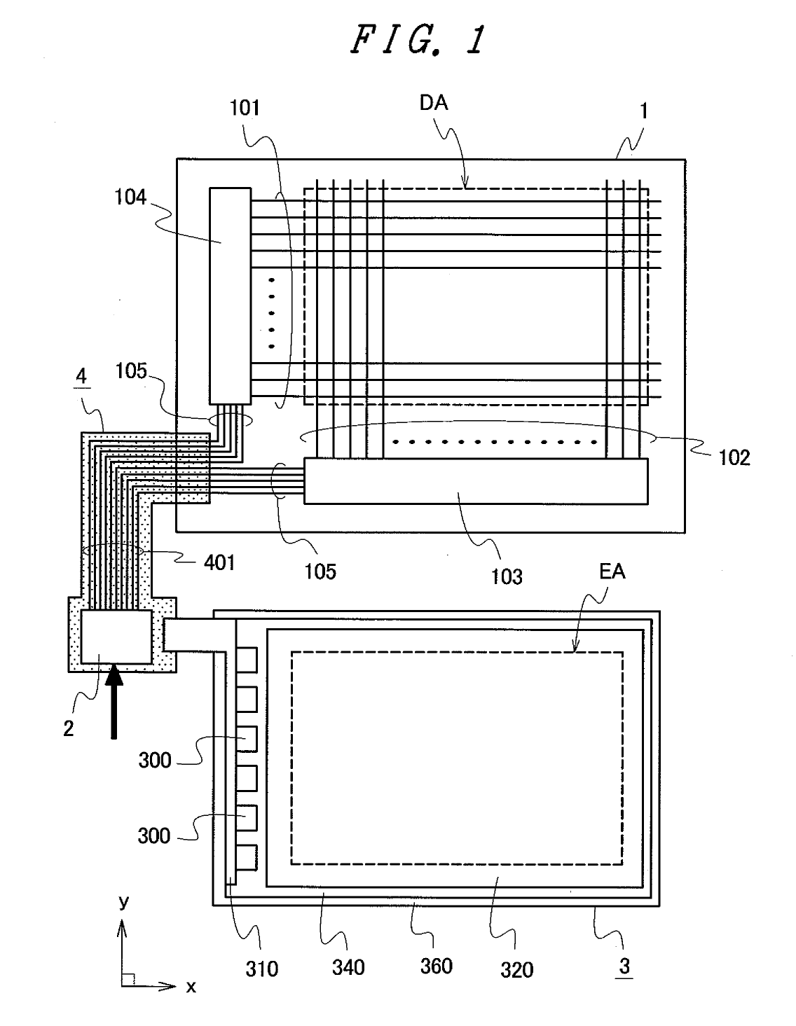

FIG. 1 is a schematic view showing an example of a schematic configuration of a liquid crystal display device of an embodiment according to the invention.

The invention is applied to, for example, a liquid crystal display device having a light guide plate type backlight. The liquid crystal display device includes, for example, a liquid crystal display panel 1, a control circuit 2, and a backlight as a planar lighting device. The control circuit 2 is formed on a flexible wiring board 4 where wirings 401 or the like are disposed on the surface of a film-like insulating substrate (not shown), for example.

The liquid crystal display panel 1 is a display panel having a liquid crystal material sealed between a pair of substrates. A plurality of scanning signal lines 101 (also referred to as scanning lines, gate signal lines, or gate lines), and a plurality of video signal lines 102 (also referred to as video lines, drain lines, or drain signal lines) are disposed on one substrate of the pair of substrates. A display region DA corresponds to a region surrounded by two scanning signal lines 101 arranged at the outermost side and two video signal lines 102 arranged at the outermost side. In FIG. 1, only part of the plurality of scanning signal lines 101 and part of the plurality of video signal lines 102 are shown, and more scanning signal lines 101 and more video signal lines 102 are actually disposed.

The display region DA is formed by an assembly of a plurality of pixels. A region occupied by one pixel corresponds to a region surrounded by two adjacent scanning signal lines 101 and two adjacent video signal lines 102. Each pixel in the display region DA includes a switching element (TFT element), a pixel electrode, a liquid crystal layer, and a counter electrode which are not shown.

The plurality of video signal lines 102 are connected to a first drive circuit 103, and the plurality of scanning signal lines 101 are connected to a second drive circuit 104. The first drive circuit 103 and the second drive circuit 104 are connected to the control circuit 2 via signal input wirings 105 disposed on the liquid crystal display panel 1 and the wirings 401 of the flexible wiring board 4.

The liquid crystal display panel 1 in the liquid crystal display device according to the invention is a liquid crystal display panel referred to as of an active matrix type. For the configuration of each pixel of the display region DA, that is, the configuration of the switching element (TFT element), pixel electrode, liquid crystal layer, and counter electrode, various configurations have heretofore been known. The configuration of each pixel in the liquid crystal display device according to the invention may employ any of the heretofore known configurations or the application thereof. Therefore, detailed description relating to the configuration of each pixel in the liquid crystal display panel 1 is omitted in the specification.

The first drive circuit 103 generates a gray scale voltage applied to a pixel electrode of each pixel based on a video signal, power supply voltage, and clock signal input from the control circuit 2 via the wirings 401 and 105. Further, the first drive circuit 103 is a circuit which supplies the generated gray scale voltage to each of the video signal lines 102 at a predetermined timing. The second drive circuit 104 supplies a selection signal to the scanning signal lines 101 based on a control signal, power supply voltage, and clock signal input from the control circuit 2 via the wirings 401 and 105. A pixel (pixel electrode) into which the gray scale voltage applied to the video signal line 102 is written is selected by the selection signal. Various configurations have heretofore been known for the configuration of the first drive circuit 103 and the second drive circuit 104. The configuration of the first drive circuit 103 and second drive circuit 104 in the liquid crystal display device according to the invention may employ any of the heretofore known configurations or the application thereof. Therefore, detailed description relating to the configuration of the first drive circuit 103 and second drive circuit 104 is omitted in the specification. Also in this case, it is apparent that the first drive circuit 103 and the second drive circuit 104 may be an IC chip on which each of the drive circuits is formed, or may be incorporated into one substrate of the liquid crystal display panel 1.

The backlight 3 is a planar lighting device for irradiating the liquid crystal display panel 1 with light in a planar shape. The backlight 3 has a plurality of light emitting elements 300, a printed wiring board 310 (circuit board), a light guide plate 320, a resin mold 340, and a housing case 360, and further has a not-shown prism sheet, light diffuser, or the like. The plurality of light emitting elements 300 are light emitting diodes (LEDs) having a configuration described later and mounted on the printed wiring board 310. An external terminal (not shown) of each of the light emitting elements 300 is connected to the control circuit 2 via a not-shown wiring of the printed wiring board 310 and a not-shown wiring of the flexible wiring board 4.

FIG. 1 shows the liquid crystal display panel 1 and the backlight 3 arranged vertically. However, they are arranged in the actual liquid crystal display device such that the display region DA of the liquid crystal display panel 1 and a region EA of the light guide plate 320 are overlapped with each other.

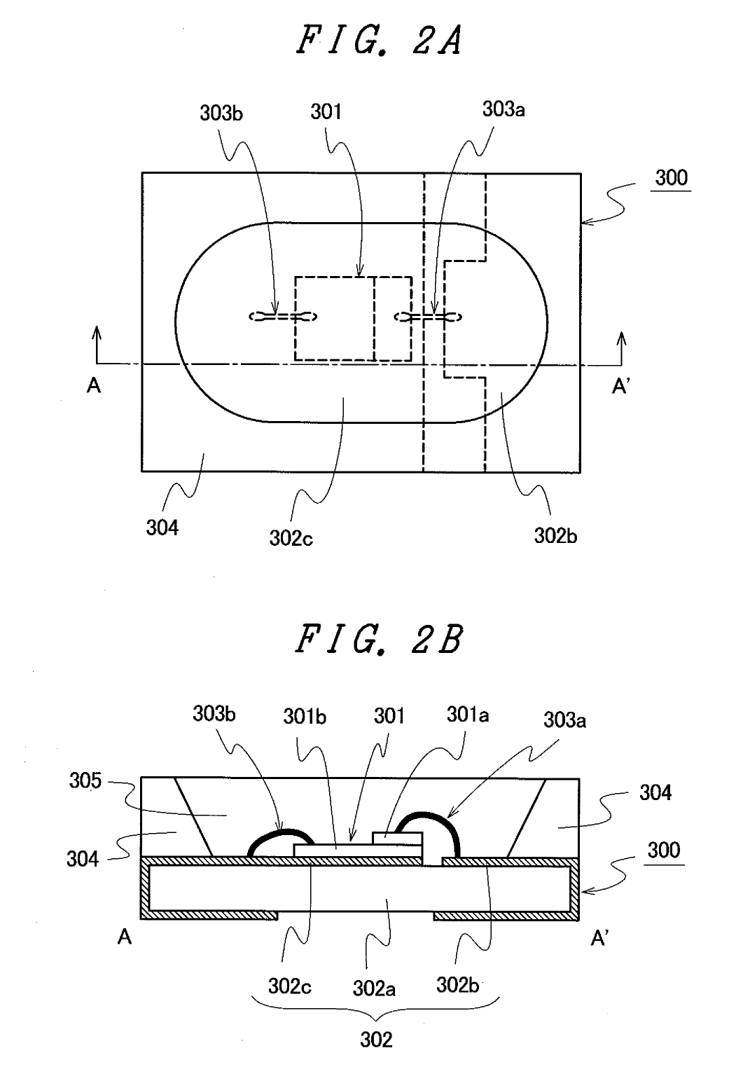

FIGS. 2A and 2B are schematic views showing an example of a schematic configuration of a light emitting element in the liquid crystal display device of the embodiment.

FIG. 2A is a schematic plan view of the light emitting element in the liquid crystal display device of the embodiment as viewed from the light exit surface. FIG. 2B is a schematic view showing an example of a cross sectional configuration of the light emitting element as viewed upwardly from line A-A′ in FIG. 2A.

The light emitting element 300 in the liquid crystal display device of the embodiment is a light emitting diode (LED) and has a configuration as shown in, for example, FIGS. 2A and 2B.

The light emitting diode 300 has an LED chip 301 as a light emitting component. The LED chip 301 is mounted on a chip substrate 302 where a first terminal 302b and a second terminal 302c are disposed on the surface of an insulating substrate 302a. In this case, the second terminal 302c has a chip mounting portion (not shown), and the LED chip 301 is mounted on the chip mounting portion of the second terminal 302c.

The LED chip 301 has a pn junction portion at the interface between a p-type semiconductor layer 301a and an n-type semiconductor layer 301b and emits a light having a specific wavelength when a voltage is applied to the pn junction portion. The p-type semiconductor layer 301a is provided with a p-electrode (anode), while the n-type semiconductor layer 301b is provided with an n-electrode (cathode). The p-electrode is electrically connected to the first terminal 302b of the chip substrate 302 via a wire 303a, while the n-electrode is electrically connected to the second terminal 302c of the chip substrate 302 via a wire 303b.

A reflecting member 304 having a cone-shaped reflecting surface which surrounds the LED chip 301 is mounted on the chip substrate 302. The light emitted by the LED chip 301 is reflected by the reflecting member 304 and exits from above. Further, a fluorescent light emitting portion 305 having a function of converting the wavelength of the light emitted from the LED chip 301 is disposed in some cases on the light exit surface side of the LED chip 301.

Each of the first terminal 302b and second terminal 302c of the chip substrate 302 extends from the chip mounting surface of the insulating substrate 302a through the side surface to the back surface side of the chip mounting surface. Therefore, in the case where the first terminal 302b and the second terminal 302c are formed of a metal having a high optical reflectivity, the chip mounting portion of the second terminal 302c can be used as a light reflecting surface. When the first terminal 302b and the second terminal 302c are formed of a metal having a high thermal conductivity (conductive member is also applicable), the heat generated by the LED chip 301 can be effectively dissipated to the back surface side of the chip substrate 302.

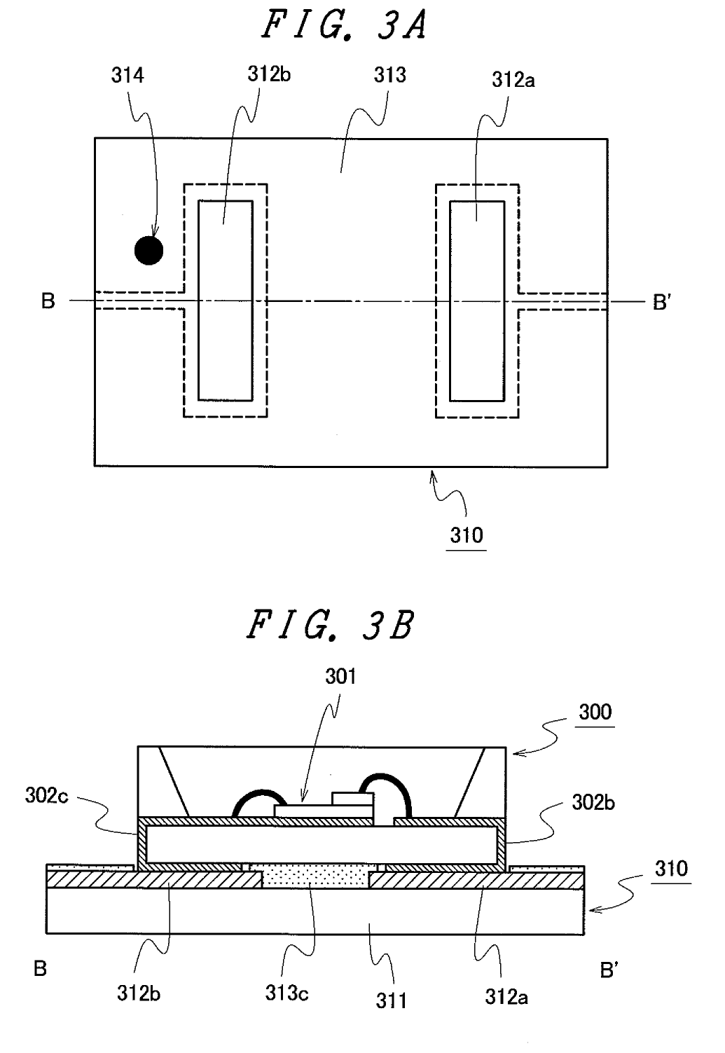

FIGS. 3A and 3B are schematic views showing an example of a mounting method of a light emitting diode on a printed wiring board.

FIG. 3A is a schematic plan view showing an example of a schematic configuration of a region and its vicinity where one light emitting diode is to be mounted in the printed wiring board. FIG. 3B is a schematic cross sectional view showing an example of a cross sectional configuration taken along line B-B′ when a light emitting diode is mounted on the region shown in FIG. 3A.

A flexible printed board (FPC) can be used for the printed wiring board 310. The FPC includes a flexible, film-like base material 311. Wirings formed of a conductive layer such as of copper foil are formed on the surface of the base material 311. A pair of wirings of a first wiring 312a and a second wiring 312b is disposed on the surface of the base material 311 in a potion where one light emitting diode 300 is mounted in the printed wiring board 310 as shown in FIGS. 3A and 3B, for example. The first wiring 312a has a pad portion which is electrically connected to the first terminal 302b of the light emitting diode 300, while the second wiring 312b has a pad portion which is electrically connected to the second terminal 302c of the light emitting diode 300. An insulating layer 313 (protective film) in which the pad portions of the wirings 312a and 312b are opened is disposed on the surface of the base material 311. A mark 314 indicating which of the first wiring 312a and the second wiring 312b is to be connected to the cathode (or anode) of the light emitting diode 300 is printed on the surface of the insulating layer 313 as shown in FIG. 3A, for example.

When the base material 311 of the printed wiring board 310 is formed of a material having good thermal conductivity, the heat conducted from the LED chip 301 to the back surface side of the chip substrate 302 can be effectively dissipated. In order to enhance the heat dissipation efficiency, for example, it is desirable that the insulating layer 313 be made as thin as possible within a range not causing a problem such as short circuit or leakage. In the embodiment, the insulating layer 313 having a thickness of 0.12 mm is formed by using an insulating material having a thermal conductivity of 6.5 W/m·K.

The first terminal 302b and second terminal 302c of the light emitting diode 300 are electrically connected respectively to the pad portions disposed at end portions of the first wiring 312a and second wiring 312b of the printed wiring board 310. The connection between the first wiring 312a and the first terminal 302b, and the connection between the second wiring 312b and the second terminal 302c are carried out by a solder reflow process in which a solder paste coated by printing on the pad portions of the first wiring 312a and second wiring 312b is heated to bond them together. Therefore, the insulating layer 313 described above is previously formed on the surface of the printed wiring board 310, so that the short circuit between the wirings 312a and 312b and another constituent material is prevented on the surface side of the printed wiring board 310, and insulation between the pads are ensured.

That is, the insulating layer 313 is preferably a member having low affinity with solder (bonding material) because a solder reflow process is carried out and preferably achromatic because it is formed on the surface of the printed wiring board 310. In this case, the insulating layer 313 is desirably white with much reflected light or of another color close to white in view of, for example, the light use efficiency. Therefore, for example, titanium oxide having high reflectivity is suitable for the material of the insulating layer 313.

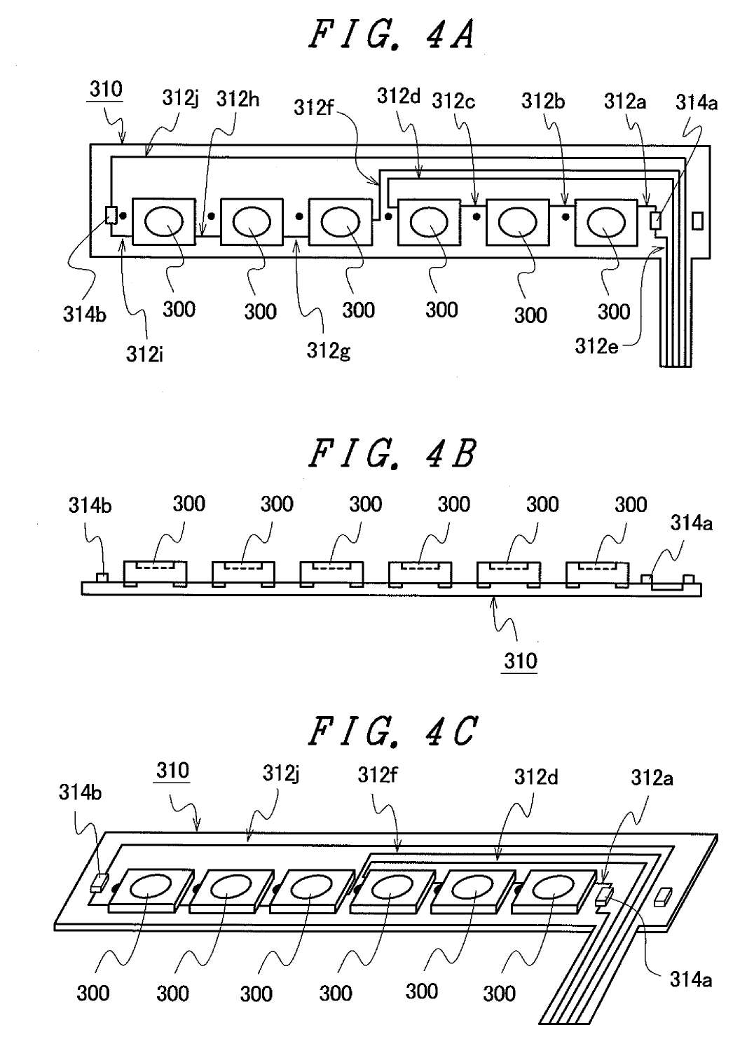

FIGS. 4A to 4C are schematic views showing an example of an overall schematic configuration of a printed wiring board on which light emitting diodes are mounted.

FIG. 4A is a schematic plan view showing an example of a schematic configuration of the printed wiring board as viewed from the light exit surface of the light emitting diodes. FIG. 4B is a schematic side view showing an example a schematic configuration of the printed wiring board in FIG. 4A as viewed from the lower side surface. FIG. 4C is a schematic perspective view showing an example of a schematic configuration of the printed wiring board in FIG. 4A as viewed obliquely from the lower right side.

When the light emitting diodes 300 are mounted on the printed wiring board 310, six light emitting diodes 300 are linearly arranged and mounted on the same surface of one printed wiring board 310 as shown in FIGS. 4A to 4C, for example. Although the six light emitting diodes 300 are mounted in the example shown in FIGS. 4A to 4C, this is not restrictive. It is apparent that from 2 to 5 light emitting diodes 300 or more than 6 light emitting diodes 300 may be mounted.

In the light emitting diode 300, a constant voltage difference is generated in the pn junction portion in view of the characteristics as a diode. Since the voltage difference in the pn junction portion varies depending on a manufacturing process, it is necessary to adjust a voltage such that an optimum voltage is applied to the pn junction portion by using, for example, an adjusting circuit in order to uniform the luminance efficiencies (luminances) of the light emitting diodes 300. In this case, however, when M (M is integer of 2 or more) light emitting diodes 300 mounted on the printed wiring board 310 are connected in parallel, M adjusting circuits are required to adjust a voltage applied to each of the pn junction portions of the light emitting diodes 300, resulting in a problem of increasing the manufacturing cost for the adjustment.

Therefore, in the backlight 3 of the embodiment, the six light emitting diodes 300 are divided into two groups each having three diodes as shown in FIGS. 4A to 4C, in which the light emitting diodes in one group (three light emitting diodes 300) are connected in series with one another to adjust a voltage applied to each group of the light emitting diodes 300. In this case, the three light emitting diodes 300 on the right side in FIGS. 4A to 4C are connected in series with one another by five wirings of wirings 312a, 312b, 312c, 312d, and 312e, with an adjusting circuit 314a disposed between the wirings 312a and 312e. The three light emitting diodes 300 on the left side in FIGS. 4A to 4C are connected in series with one another by five wirings of wirings 312f, 312g, 312h, 312i, and 312j, with an adjusting circuit 314b disposed between the wirings 312i and 312j.

In the case where a power supply voltage for lighting the light emitting diodes 300 is 12 volt which is used for, for example, in-vehicle use or the like, and a potential difference generated at each of the light emitting diodes 300 is about 4 volt, it is efficient to connect three light emitting diodes 300 in series with one another as described above. That is, it is efficient that the relationship among a power supply voltage V (volt), an average potential difference Vd (volt) generated at the light emitting diode 300, and the number m of the light emitting diodes 300 to be connected in series with one another is made so as to satisfy V≧m×Vd. That is, in the case where a potential difference generated at each of the light emitting diodes 300 is about 3 volt, and a power supply voltage is 12 volt, it is efficient to connect four light emitting diodes 300 in series with one another.

In the case where a voltage to be applied to m light emitting diodes 300 connected in series with one another is adjusted, for example, adjusting circuits 314a and 314b such as resistances are inserted between the last (last stage) light emitting diode among the m light emitting diodes 300 connected in series with one another and a ground potential.

The configuration shown in FIGS. 4A to 4C is one example of the configuration of the printed wiring board 310 on which the light emitting diodes 300 are mounted and the mounting method of the light emitting diodes 300. That is, in the backlight 3 of the embodiment, this is not restrictive. It is apparent that the configuration of the printed wiring board 310 and the mounting method of the light emitting diodes 300 can be properly modified.

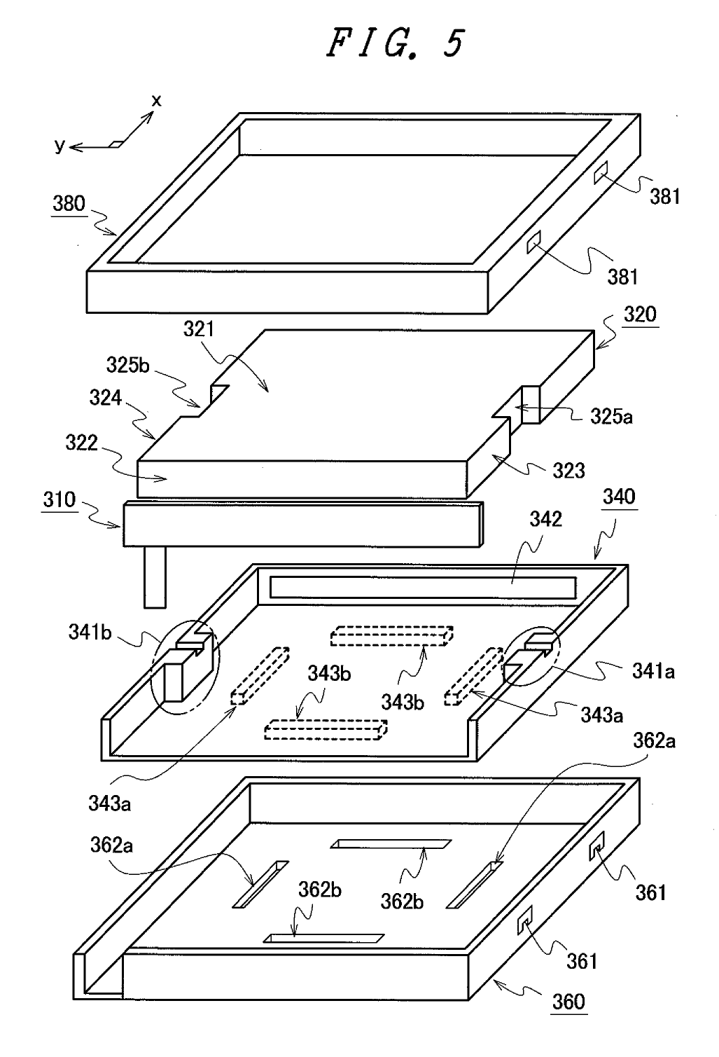

FIG. 5 is a schematic exploded perspective view showing an example of a schematic configuration of the backlight in the liquid crystal display device of the embodiment.

The backlight 3 in the liquid crystal display device of the embodiment has a configuration in which the light guide plate 320 is vertically sandwiched between a substantially box-shaped housing case 360 and a frame-like member 380 as shown in FIG. 5, for example. The housing case 360 is formed by molding a metal plate into a box shape by press working and has first engaging portions 361 on the side surface. The frame-like member 380 is formed by molding a band-like metal plate into a frame shape by bending or the like, for example, and has second engaging portions 381 at positions corresponding to the first engaging portions 361.

The light guide plate 320 is made of, for example, a transparent resin such as an acrylic resin, in which one side surface among side surfaces in contact with a light outgoing surface 321, that is, a surface facing the light emitting diodes (not shown) mounted on the printed wiring board 310 is a light incoming surface 322.

The light outgoing surface 321 and the back surface thereof (hereinafter referred to as a bottom surface) has a constant interval. The light emitted from the light emitting diode 300 is incident from the light incoming surface 322 to the light guide plate 320, and thereafter travels through the light guide plate 320 while repeating a total reflection on the light outgoing surface 321 and the bottom surface. The light guide plate 320 is provided with a scattering member on the bottom surface, for example. When an incident angle at which the light scattered by the scattering member is incident on the light outgoing surface 321 is smaller than a predetermined angle (critical angle), the light is refracted on the light outgoing surface 321 and exits to the liquid crystal display panel side.

The light guide plate 320 is housed in the housing case 360 in a state of being fixed (housed) to the substantially box-shaped resin mold 340 with one side surface opened. The light guide plate 320 has recessed fixing portions 325a and 325b disposed respectively on two side surfaces 323 and 324 which face each other with the light incoming surface 322 interposed therebetween. The resin mold 340 has light-guide-plate-fixing projecting portions 341a and 341b at positions corresponding to the fixing portions 325a and 325b of the light guide plate 320. The fixing portions 325a and 325b of the light guide plate 320 and the light-guide-plate-fixing projecting portions 341a and 341b of the resin mold 340 are fitted together to fix the light guide plate 320 to the resin mold 340. Further, for example, when a cushion material 342 is interposed between a side surface opposite to the light incoming surface 322 of the light guide plate 320 and the resin mold 340, an effect of fixing the light guide plate 320 is enhanced.

A plurality of protruding portions 343a and 343b are disposed on the bottom surface of the resin mold 340 (surface facing the bottom surface of the housing case 360). A plurality of opening portions 362a and 362b corresponding to the protruding portions 343a and 343b of the resin mold 340 are disposed on the bottom surface of the housing case 360. In a state where the protruding portions 343a and 343b of the resin mold 340 and the opening portions 362a and 362b of the housing case 360 are fitted together, for example, the first engaging portions 361 of the housing case 360 and the second engaging portions 381 of the frame-like member 380 are caulked together, so that the resin mold 340 and the light guide plate 320 are fixed to the bottom surface of the housing case 360.

The printed wiring board 310 on which the light emitting diodes 300 are mounted is attached to a side surface (not shown), which faces the light incoming surface 322 of the light guide plate 320, of the housing case 360, for example. Since the housing case 360 is formed of a metal or the like having good thermal conductivity, the heat generated by the light emitting diodes 300 can be effectively dissipated by firmly attaching the printed wiring board 310 to the housing case 360.

Further, the positional relationship (distance) between the light emitting diodes 300 and the light incoming surface 322 of the light guide plate 320 can be stabilized by fixing the light guide plate 320 to the resin mold 340 and fixing the resin mold 340 to the housing case 360.

The light guide plate 320 can be directly housed in and fixed to the housing case 360. However, in the case where the light guide plate 320 made of resin is directly housed in the housing case 360 made of metal, a problem arises in that the resin-made light guide plate 320 is scraped due to, for example, the friction therebetween caused by vibration.

On the other hand, in the backlight 3 of the embodiment, the light guide plate 320 is housed in the housing case 360 in a state of being fixed to the resin mold 340, and the light guide plate 320 is in contact with the resin mold 340. Therefore, it is possible to suppress the occurrence of the problem that the light guide plate 320 is scraped due to vibration or the like. In the backlight 3 of the embodiment, although dust might be produced from the resin mold 340 by being scraped due to, for example, vibration, the portion where the resin mold 340 and the housing case 360 are fixed together is disposed on the lower surface. Therefore, it is possible to prevent the dust produced from the resin mold 340 by being scraped from entering, for example, above the light outgoing surface 321 of the light guide plate 320 or between the light guide plate 320 and the resin mold 340.

Further, in the backlight 3 of the embodiment, the light guide plate 320 and the resin mold 340 are fixed together at the fixing portions 325a and 325b disposed on side surfaces 323 and 324 of the light guide plate 320 and the light-guide-plate-fixing projecting portions 341a and 341b of the resin mold 340. When the distance between the light incoming surface 322 and the light exit surface of the light emitting elements (the light emitting diodes 300) is changed, the light amount of the light exited from the light outgoing surface 321 of the light guide plate 320 is greatly changed. Therefore, the light guide plate 320 and the resin mold 340 are fixed at the fixing portions 325a and 325b disposed on the side surfaces 323 and 324 to suppress misalignment in a normal line direction (x direction) of the light incoming surface 322, whereby the change in the distance between the light incoming surface 322 and the light emitting diodes 300 can be effectively reduced.

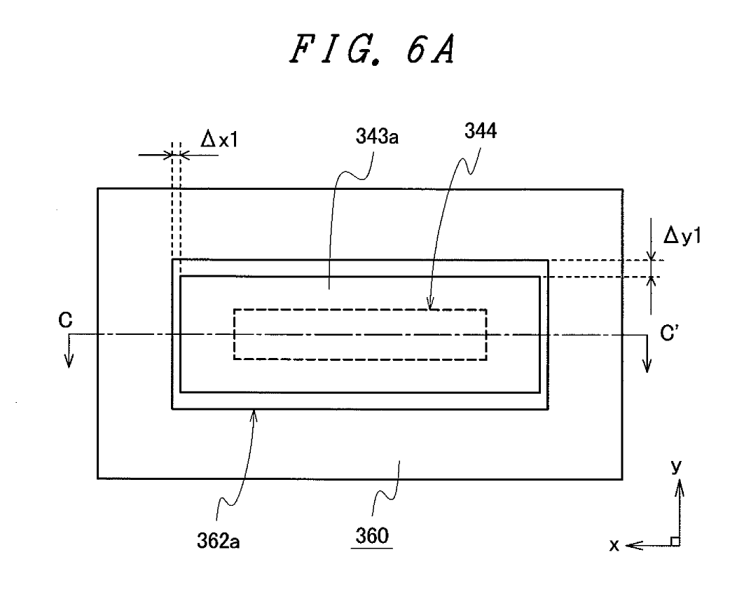

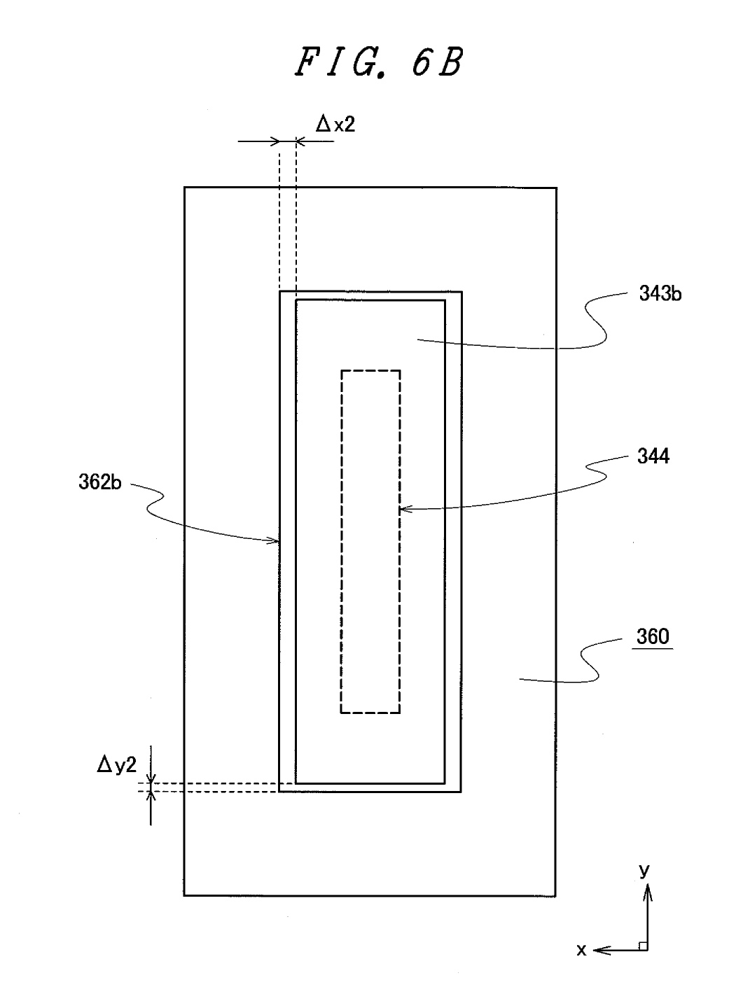

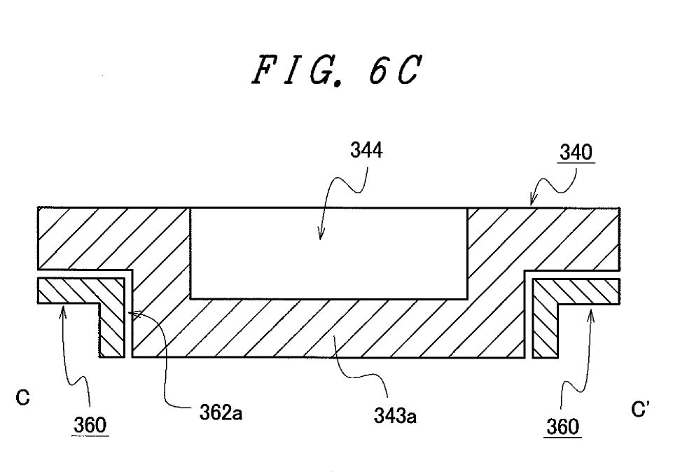

FIGS. 6A to 6C are schematic views showing an example of a more preferable configuration in the backlight of the embodiment.

FIG. 6A is a schematic plan view showing an example of a schematic configuration of a portion where one protruding portion of a resin mold and an opening portion of a housing case are fitted together. FIG. 6B is a schematic plan view showing an example of a schematic configuration of a portion where another protruding portion of the resin mold and another opening portion of the housing case are fitted together. FIG. 6C is a schematic cross sectional view showing an example of a state where the protruding portion of the resin mold and the opening portion of the housing case are fitted together as viewed downwardly from line C-C′ in FIG. 6A.

FIGS. 6A and 6B are plan views as viewed from the back surface side of the housing case. The x direction and y direction in FIGS. 6A and 6B are the same directions as those in FIG. 5.

The resin mold 340 used for the backlight 3 of the embodiment is provided with the four protruding portions 343a and 343b on the surface facing the housing case 360 as shown in FIG. 5, for example. In this case, the shape of each of the four protruding portions 343a and 343b is a substantially rectangular parallelepiped having two side surfaces extending in a first direction (x direction) and two side surfaces extending in a second direction (y direction). Also in this case, the two protruding portions 343a among the four protruding portions 343a and 343b each have longer side surfaces extending in the x direction, while the remaining two protruding portions 343b each have longer side surfaces extending in the y direction.

The protruding portion 343a having longer side surfaces extending in the x direction and the opening portion 362a of the housing case 360 are fitted together such that a gap Δx1 between the side surface of the protruding portion 343a extending in the y direction and the housing case 360 is smaller than a gap Δy1 between the side surface of the protruding portion 343a extending in the x direction and the housing case 360 as shown in FIG. 6A, for example.

Further, the protruding portion 343b having longer side surfaces extending in the y direction and the opening portion 362b of the housing case 360 are fitted together such that a gap Δy2 between the side surface of the protruding portion 343b extending in the x direction and the housing case 360 is smaller than a gap Δx2 between the side surface of the protruding portion 343b extending in the y direction and the housing case 360 as shown in FIG. 6B, for example.

In the case where the resin mold 340 and the housing case 360 are fixed together by the method as shown in FIGS. 6A and 6B, misalignment between the resin mold 340 and the housing case 360 in the x direction can be suppressed by the fit between the protruding portion 343a having longer side surfaces extending in the x direction and the opening portion 362a of the housing case 360. Further, misalignment between the resin mold 340 and the housing case 360 in the y direction can be suppressed by the fit between the protruding portion 343b having longer side surfaces extending in the y direction and the opening portion 362b of the housing case 360.

Also in this case, the protruding portion 343a having longer side surfaces extending in the x direction and the opening portion 362a of the housing case 360 are fitted together such that the gap Δy1 between the side surface of the protruding portion 343a extending in the x direction and the opening portion 362a of the housing case 360 is large. Therefore, for example, the deformation of the protruding portion 343a due to heat can be absorbed, whereby positional misalignment or the like can be prevented. Similarly, the protruding portion 343b having longer side surfaces extending in the y direction and the opening portion 362b of the housing case 360 are fitted together such that the gap Δx2 between the side surface of the protruding portion 343b extending in the y direction and the opening portion 362b of the housing case 360 is large. Therefore, for example, the deformation of the protruding portion 343b due to heat can be absorbed, whereby positional misalignment or the like can be prevented.

Further, the resin mold 340 is desirably provided with a recessed portion 344 on the back surface of the bottom surface having the protruding portion 343a at a position where the protruding portion 343a is disposed. In this case, the recessed portion 344 on the back surface of the protruding portion 343a is formed to have such a size that, for example, the thickness of the resin mold in the protruding portion 343a is substantially equal to that of a portion where the protruding portion 343a is not disposed. Also in this case, a similar recessed portion 344 is disposed on the back surface side of the protruding portion 343b although not shown. As described above, the thickness of the resin mold in the protruding portions 343a and 343b is adjusted to that of another portion, whereby the amount of contraction due to heat, for example, can be adjusted between the protruding portions 343a and 343b and another portion, and deformation due to heat can be prevented.

Accordingly, in the backlight 3 of the embodiment, the protruding portions 343a and 343b of the resin mold 340 and the opening portions 362a and 362b of the housing case 360 are configured as shown in FIGS. 6A to 6C, whereby the alignment accuracy between the resin mold 340 and the housing case 360 can be enhanced. At the same time, deformation due to heat or the like can be prevented. Therefore, the alignment accuracy between the light guide plate 320 and the light emitting diodes 300 can be enhanced, and the reliability of the backlight 3 can be improved.

As described above, according to the backlight 3 of the embodiment, the heat of the light emitting elements 300 can be effectively dissipated. Further, according to the backlight 3 of the embodiment, the alignment between the light emitting elements 300 and the light guide plate 320 is easy. Still further, according to the backlight 3 of the embodiment, for example, the positional misalignment between the light emitting elements 300 and the light guide plate 320 due to heat, vibration, or the like can be also suppressed, whereby the position relationship therebetween can be stabilized. Therefore, a liquid crystal display device having the backlight 3 of the embodiment can improve the reliability of the backlight 3.

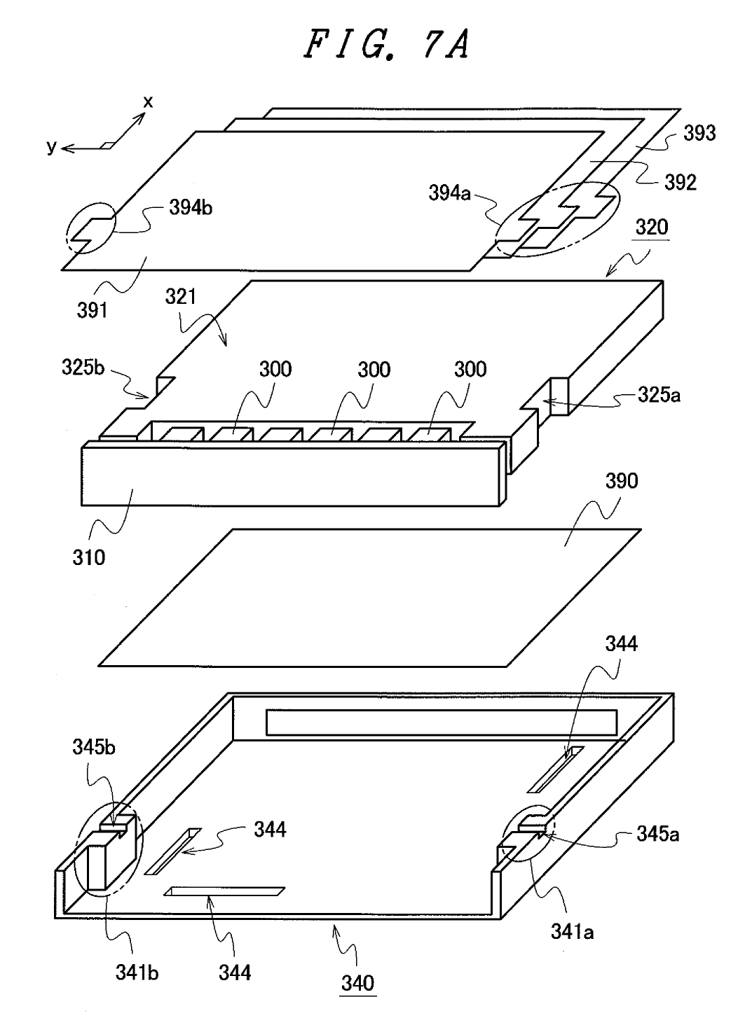

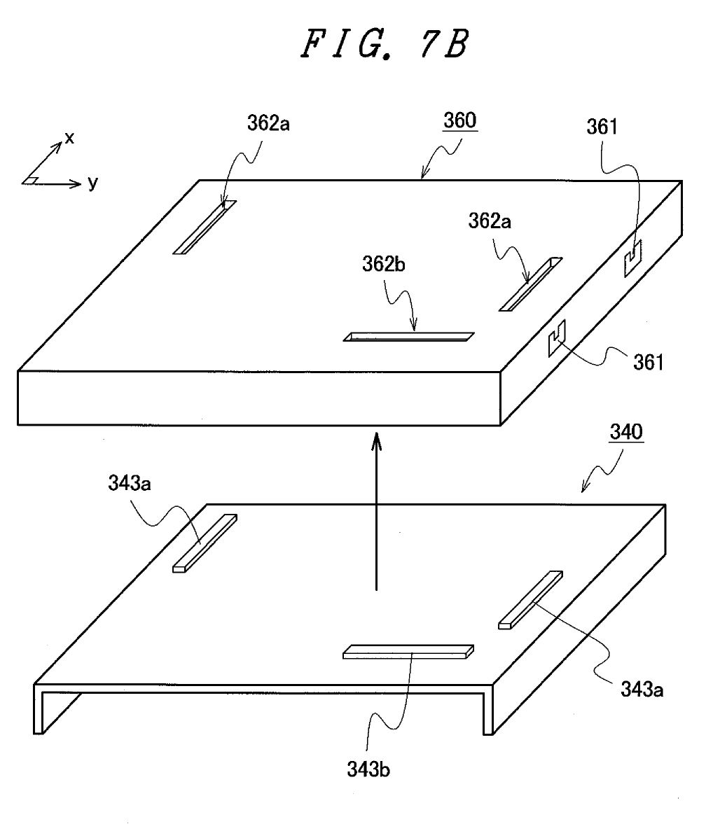

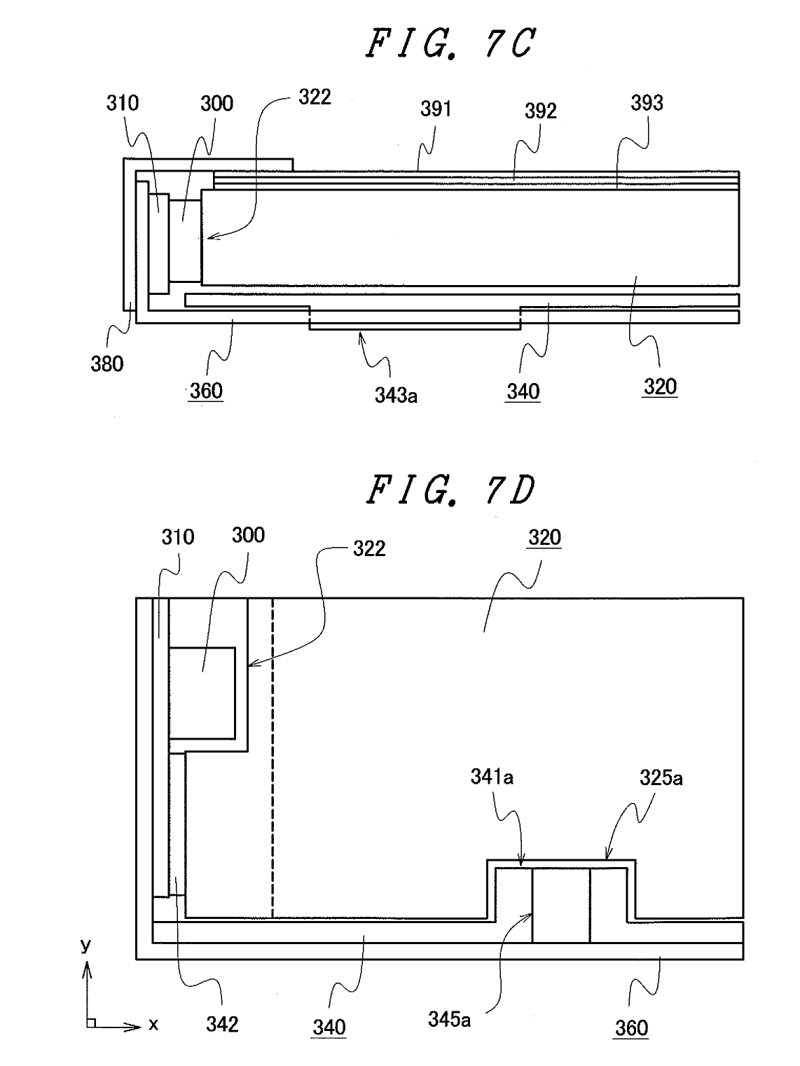

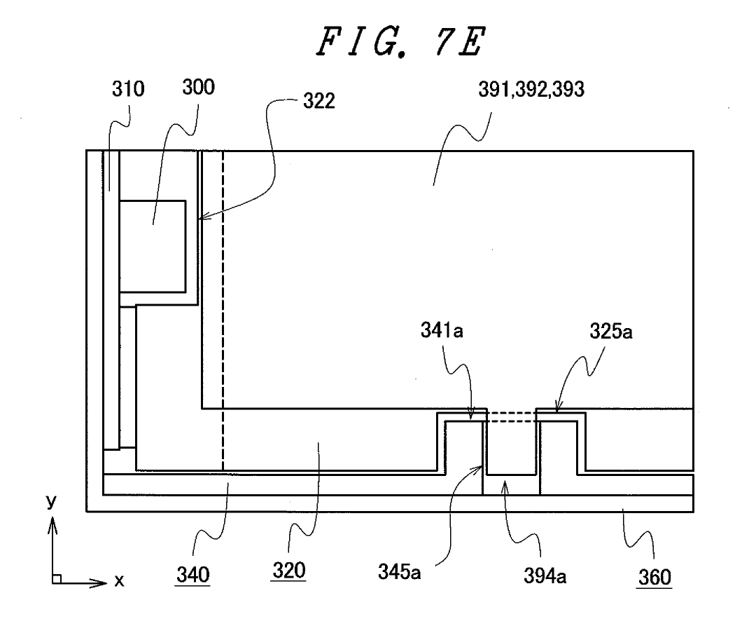

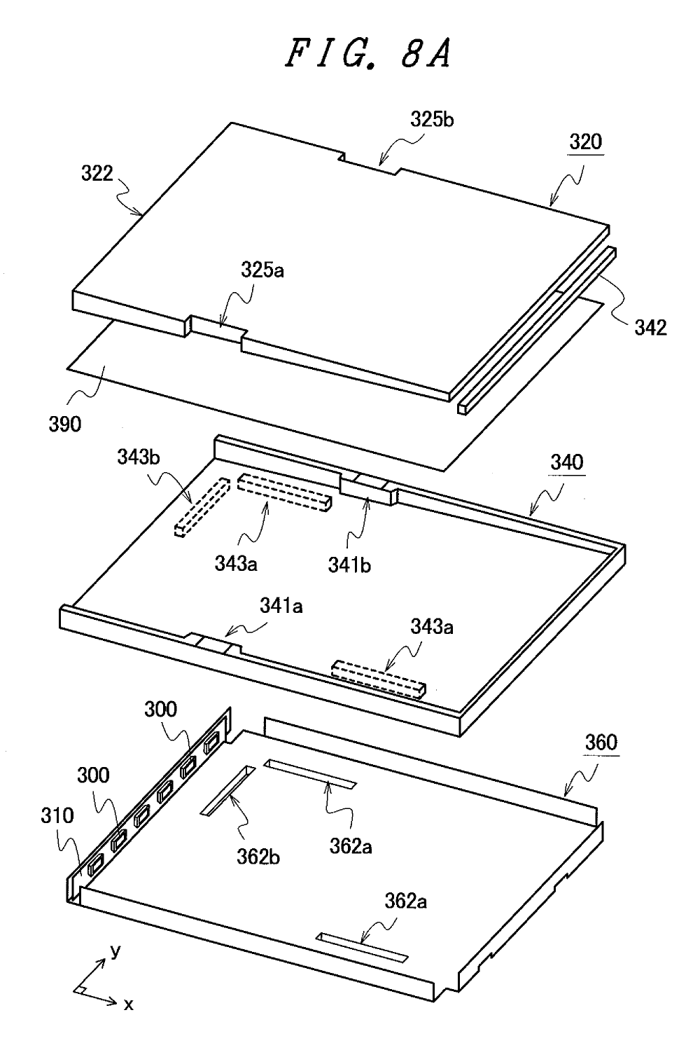

FIGS. 7A to 7E are schematic views showing a first application example of the backlight of the embodiment.

FIG. 7A is a schematic exploded perspective view showing an example of a schematic configuration of the backlight of the first application example. FIG. 7B is a schematic exploded perspective view showing the relationship between protruding portions of a resin mold and opening portions of a housing case in the backlight of the first application example. FIG. 7C is a schematic cross sectional view showing an example of a schematic configuration in the vicinity of a light emitting diode in the backlight of the first application example. FIG. 7D is a schematic plan view showing an example of a fixing method of a light guide plate in the backlight of the first application example. FIG. 7E is a schematic plan view showing an example of a fixing method of optical sheets in the backlight of the first application example.

The x direction and y direction in FIGS. 7B, 7D, and 7E are the same directions as those in FIG. 7A.

In the first application example of the backlight 3 of the embodiment, three protruding portions 343a and 343b are disposed on the surface, which faces the housing case 360, of the resin mold 340 as shown in FIGS. 7A and 7B, for example. In this case, the two protruding portions 343a among the three protruding portions 343a and 343b each are a rectangular parallelepiped having longer side surfaces extending in the x direction. The relationship between the protruding portion 343a and the opening portion 362a of the housing case 360 is as shown in FIG. 6A, for example. In this case, the remaining protruding portion 343b is a rectangular parallelepiped having longer side surfaces extending in the y direction. The relationship between the protruding portion 343b and the opening portion 362b of the housing case 360 is as shown in FIG. 6B, for example. Further, it is desirable to dispose the recessed portion 344 on the back surface of each of the protruding portions 343a and 343b. With such a configuration, in the backlight 3 of the first application example, the alignment between the resin mold 340 and the housing case 360 is easy, and an effect of suppressing the positional misalignment can be enhanced.

The light guide plate 320 has the recessed fixing portions 325a and 325b disposed respectively on the two side surfaces 323 and 324 which face each other with the light incoming surface 322 interposed therebetween. The resin mold 340 has the light-guide-plate-fixing projecting portions 341a and 341b at positions corresponding to the fixing portions 325a and 325b of the light guide plate 320. Therefore, the fixing portions 325a and 325b of the light guide plate 320 and the light-guide-plate-fixing projecting portions 341a and 341b of the resin mold 340 are fitted together, whereby the light guide plate 320 can be fixed to the resin mold 340.

In the case of the general light guide plate type backlight 3, a reflective sheet 390 is disposed between the bottom surface of the light guide plate 320 and the resin mold 340 as shown in FIG. 7A, for example, in order to make the light which is refracted on and exits from the bottom surface of the light guide plate 320 incident again on the light guide plate 320.

In the case of the general light guide plate type backlight 3, optical sheets such as prism sheets 391 and 392 and a light diffuser 393 are disposed on the light outgoing surface 321 of the light guide plate 320 as shown in FIG. 7A, for example. In this case, in the backlight 3 of the first application example, for example, optical sheet holding portions 394a and 394b are disposed to each of the prism sheets 391 and 392 and the light diffuser 393. Also in this case, in the backlight 3 of the first application example, optical sheet fixing portions 345a and 345b which fit to the optical sheet holding portions 394a and 394b are disposed at the light-guide-plate-fixing projecting portions 341a and 341b of the resin mold 340 as shown in FIG. 7A, for example.

In the backlight 3 with such a configuration, the printed wiring board 310 on which the light emitting diodes 300 are mounted is firmly attached to the side surface of the housing case 360 as shown in FIG. 7C, for example, and therefore the heat generated by the light emitting diodes 300 can be effectively dissipated. The resin mold 340 is fixed to the housing case 360 by fitting the protruding portions 343a and 343b to the opening portions 362a and 362b of the housing case 360.

In this case, the light guide plate 320 is fixed to the resin mold 340 by fitting the fixing portion 325a of the side surface 323 to the light-guide-plate-fixing projecting portion 341a of the resin mold 340 as shown in FIG. 7D, for example. Also in this case, the cushion material 342 is interposed between the light guide plate 320 and the printed wiring board 310 to reduce the change in the distance between the light exit surface of the light emitting diodes 300 and the light incoming surface of the light guide plate 320.

Further, the positional misalignment among the prism sheets 391 and 392 and the light diffuser 393 is prevented by fitting their optical sheet holding portions 394a to the optical sheet fixing portion 345a disposed at the light-guide-plate-fixing projecting portion 341a of the resin mold 340 as shown in FIG. 7E, for example.

As described above, in the backlight 3 of the first application example, not only the change in the distance between the light emitting diodes 300 and the light incoming surface 322 of the light guide plate 320 but also the positional misalignment between the light guide plate 320 and the optical sheets (the prism sheets 391 and 392, the light diffuser 393, or the like) can be reduced.

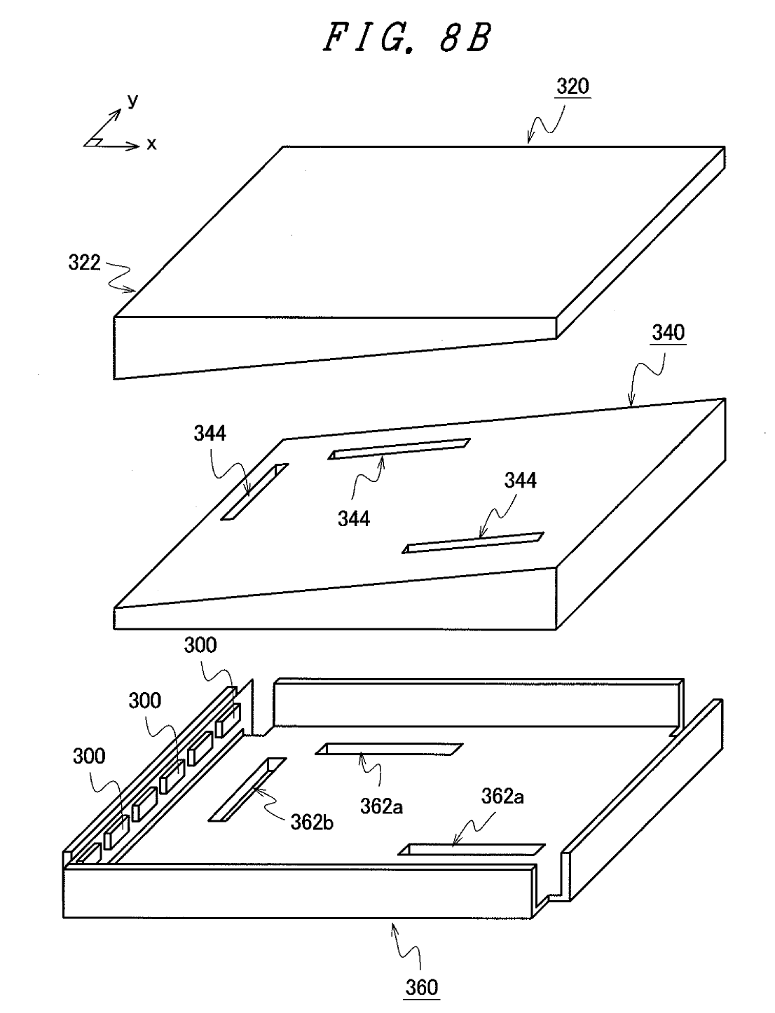

FIGS. 8A and 8B are schematic views showing a second application example of the backlight of the embodiment.

FIG. 8A is a schematic exploded perspective view showing an example of a schematic configuration of the backlight of the second application example. FIG. 8B is a schematic exploded perspective view showing the relationship among a light guide plate, a resin mold, and a housing case in the backlight of the second application example.

The x direction and y direction in FIG. 8B are the same directions as those in FIG. 8A.

The light guide plate 320 described so far has a shape in which the light outgoing surface 321 and the back surface thereof (bottom surface) are parallel with each other. However, the configuration of the embodiment is not restricted thereto. As shown in FIGS. 8A and 8B, for example, it is apparent that the configuration of the embodiment can be applied to the backlight 3 having the light guide plate 320 in which the distance between the light outgoing surface 321 and the bottom surface becomes shorter with increasing distance from the light incoming surface 322, that is, the light guide plate 320 having a wedge shape.

In this case, the resin mold 340 is formed to have such a shape that, for example, the thickness of the bottom surface portion interposed between the light guide plate 320 and the housing case 360 is greater with increasing distance from the light emitting diodes 300, that the resin mold 340 and the light guide plate 320 form a substantially rectangular parallelepiped when fixed together, and that the bottom surface of the light guide plate 320 and the resin mold 340 closely contact with each other via the reflective sheet 390.

With this configuration, the fixing between the light guide plate 320 and the resin mold 340, and the fixing between the resin mold 340 and the housing case 360 are stabilized, whereby the alignment between the light emitting diodes 300 and the light guide plate 320 is easy, and the reliability of the backlight 3 is improved.

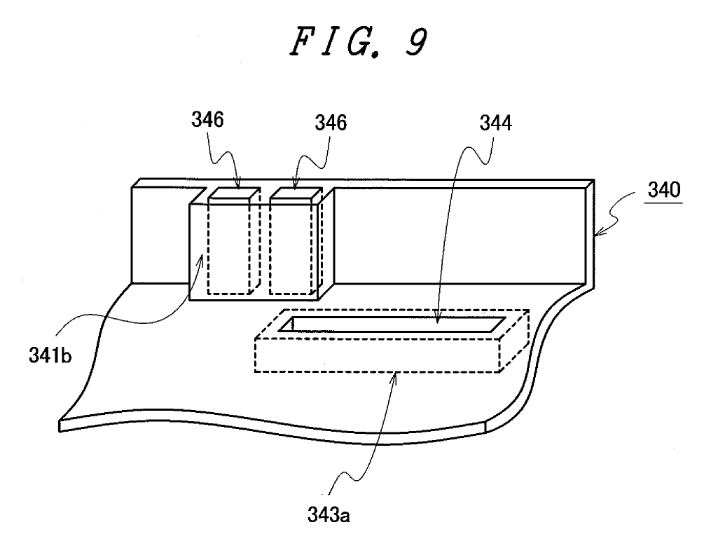

FIG. 9 is a schematic view showing a third application example of the backlight of the embodiment.

In the resin mold 340 described so far, since the thickness of the light-guide-plate-fixing projecting portions 341a and 341b disposed at positions facing the fixing portions 325a and 325b of the light guide plate 320 is greater than that of the both side portions thereof, for example, it is conceivable that deformation due to heat is likely to occur. Therefore, similarly to the protruding portions 343a and 343b to be fitted to the opening portions 362a and 362b of the housing case 360, the resin mold 340 may be provided with hollow portions 346 at the light-guide-plate-fixing projecting portion 341b disposed at a position facing the fixing portion of the light guideplate 320 as shown in FIG. 9, for example. In this manner, since the thickness of the protruding portion 341b can be equal to that of another portion by disposing the hollow portions 346 at the light-guide-plate-fixing projecting portion 341b, deformation due to heat can be suppressed, for example.

Although the invention has been specifically described so far based on the embodiment, the invention is not restricted to the embodiment. It is apparent that the invention can be variously modified within a range not departing from the gist thereof.

The backlight 3 described in the embodiment is a planar lighting device which converts the light from the light emitting elements 300 as point light sources into a planar light beam by using the light guide plate 320 and irradiates the liquid crystal display panel 1 with the light beam. Therefore, it is conceivable that the configuration of the backlight 3 of the invention can be applied to a light source for a liquid crystal display device as well as to a planar lighting device for indoor lighting or the like, for example.

What is claimed is:

1. A liquid crystal display device comprising:
a liquid crystal display panel; and
a backlight irradiating the liquid crystal display panel with light,
the backlight having
a plurality of light emitting elements,
a circuit board on which the light emitting elements are mounted,
a light guide plate irradiating the liquid crystal display panel with the light emitted from the light emitting elements,
a resin mold housing the light guide plate, and
a metal case housing the resin mold, wherein
the resin mold has a plurality of protruding portions on a bottom surface facing the metal case,
the metal case has a plurality of opening portions on a bottom surface facing the resin mold, and
the protruding portions of the resin mold and the opening portions of the metal case are fitted together.

2. A display device according to claim 1, wherein
the light emitting elements are light emitting diodes.

3. A display device according to claim 1, wherein
the plurality of light emitting elements are mounted on the circuit board.

4. A display device according to claim 1, wherein
the plurality of light emitting elements each have a light exit surface facing one side surface of the light guide plate.

5. A display device according to claim 1, wherein
the plurality of light emitting elements are linearly arranged along one side surface of the light guide plate.

6. A display device according to claim 1, wherein
the resin mold has recessed portions on a bottom surface at positions where the protruding portions are disposed.

7. A display device according to claim 1, wherein
the protruding portions of the resin mold each have first side surfaces extending in a first direction and second side surfaces extending in a second direction, and
a gap between the opening portion and the protruding portion is smaller at the second side surface than at the first side surface.

8. A display device according to claim 1, wherein
the light guide plate has recessed fixing portions respectively disposed on two side surfaces facing each other with a surface facing the liquid crystal display panel interposed therebetween,
the resin mold has projecting portions each projected to a fixing portion side at positions facing the fixing portions of the light guide plate, and
the projecting portions of the resin mold and the fixing portions of the light guide plate are fitted together.

9. A display device according to claim 1, wherein
the resin mold has a hollow portion in the projecting portion which fits to the fixing portion of the light guide plate.

10. A display device according to claim 1, further comprising:
a cushion material between the light guide plate and the resin mold.

11. A liquid crystal display device comprising:
a liquid crystal display panel; and
a backlight irradiating the liquid crystal display panel with light,
the backlight having
a plurality of light emitting elements,
a flexible printed board on which the light emitting elements are mounted,
a light guide plate irradiating the liquid crystal display panel with the light emitted from the light emitting elements,
a resin mold housing the light guide plate, and
a metal case housing the resin mold, wherein
the resin mold has a plurality of protruding portions on a bottom surface facing the metal case,
the metal case has a plurality of opening portions on a bottom surface facing the resin mold,
the protruding portions of the resin mold and the opening portions of the metal case are fitted together, and
the flexible printed board is attached to the metal case.

12. A display device according to claim 11, wherein
the light emitting elements are light emitting diodes.

13. A display device according to claim 11, wherein
the plurality of light emitting elements are mounted on the flexible printed board.

14. A display device according to claim 11, wherein
the plurality of light emitting elements each have a light exit surface facing one side surface of the light guide plate.

15. A display device according to claim 11, wherein
the plurality of light emitting elements are linearly arranged along one side surface of the light guide plate.

16. A display device according to claim 11, wherein
the resin mold has recessed portions on a bottom surface at positions where the protruding portions are disposed.

17. A display device according to claim 11, wherein
the protruding portions of the resin mold each have first side surfaces extending in a first direction and second side surfaces extending in a second direction, and
a gap between the opening portion and the protruding portion is smaller at the second side surface than at the first side surface.

18. A display device according to claim 11, wherein
the light guide plate has recessed fixing portions respectively disposed on two side surfaces facing each other with a surface facing the liquid crystal display panel interposed therebetween,
the resin mold has projecting portions each projected to a fixing portion side at positions facing the fixing portions of the light guide plate, and
the projecting portions of the resin mold and the fixing portions of the light guide plate are fitted together.

19. A display device according to claim 11, wherein
the resin mold has a hollow portion in the projecting portion which fits to the fixing portion of the light guide plate.

20. A display device according to claim 11, further comprising:
a cushion material between the light guide plate and the resin mold.
